(19) United States
(12) Patent Application Publication
(10) Pub. No.: US 2014/0011591 A1
(43) Pub. Date: Jan. 9, 2014

(54) METHOD AND SYSTEM OF ONLINE PAINTING COMPETITION PROCESSED THROUGH INTERNET

(71) Applicant: Yuan-Fong CHUNG, New Taipei City (TW)

(72) Inventor: Yuan-Fong CHUNG, New Taipei City (TW)

(21) Appl. No.: 13/923,245

(22) Filed: Jun. 20, 2013

(30) Foreign Application Priority Data
Jul. 9, 2012 (TW) 101124556

(51) Int. Cl. G07F 17/32

(52) U.S. Cl. CPC G07F 17/32
USPC 463/40

(57) ABSTRACT

The present invention relates to a method of online painting competition processed through a wired or wireless internet, including: providing a contestant inputting process, wherein after logining the website, the at least a contestant inputs at least an electronic file of an competing image; providing a viewer or a judge inputting process; providing a competing image managing process, wherein said process is served to input the electronic file of the image submitted by the at least a contestant then stored and to code the competing image with respect to the sequential order of the inputting time and to input the score given by the at least a judge then store and ranking based on the accumulated scores given by the public judges as the final result of the competition.

### BACKGROUND OF THE INVENTION

1. Field of the Invention

The present invention relates to a method of online painting competition processed through a wired or wireless internet, especially to a method by which the public being enabled to view and judge on a website after coding with respect to the sequential order of the inputting time defined by the contestant submitting the electronic file of the competing image and ranking based on the accumulated score given by the public judges and the final result of the competition being the rankings based on the accumulated score of the public judge after the preset time period for the competition.

2. Description of Related Art

A conventional painting competition is done by giving the contestant a theme and the contestant using a piece of painting paper and painting materials for painting, then submitting his/her artwork to the authorization within a preset period of time, then specialists judging and scoring those artworks and finally publishing the rankings. However, the method consumes a lot of resources, for example, the contestant has to purchase the paper and painting materials for the purpose of painting and submitting his/her finished artwork to the authorization; in addition, the authorization has to hire some specialists for being as the judges, but due to the limited budget, the number of judges hired is not a large group and the subjectivity of a few number of judges may affect the final result of the competition, thus the competition result does not often meet the expectations of the public.

### SUMMARY OF THE INVENTION

One primary objective of the present invention is to provide a method of online painting competition processed through a wired or wireless internet, in which the contestant uses a relative equipment such as a computer or a mobile communication device and a drawing software for painting and the finished painting is transferred to an electronic file, then the electronic file is inputted to the relevant website for finishing the registration, the webpage of the relevant website would show the sequential order with respect to the inputting time and the ranking based on the accumulated scores given by the public judges thereby allowing the publics to view and enquiry, and the final result of the competition is the rankings based on the accumulated score of the public judge after the preset time period for the competition.

For achieving the objectives, the present invention provides a method of online painting competition processed through a wired or wireless internet, which allows at least a contestant, at least a judge or at least a viewer to login a website through a wired or wireless internet for participating the online painting competition, and includes the following steps: providing a contestant inputting process, wherein after logining the website, the at least a contestant inputs at least an electronic file of a competing image, and the contestant is enabled to view, enquiry or modify the competing image afterwards through the internet; providing a viewer or a judge inputting process, wherein after the at least a viewer or judge logins the website, a part or all of the competing images are allowed to be viewed or to be judged, if judging is desired, the selected competing image is judged and scored for allowing other judges or viewers to be online to view, enquiry or modify the score afterwards; providing a competing image managing process, wherein the process is served to input the electronic file of the image submitted by the at least a contestant then store and in sequence code the electronic files of the competing images with respect to the inputting time, and after the score given by at least a judge is inputted and saved, the scores given by all public judges are accumulated and calculated for ranking based on the accumulated scores; and the rankings is in sequence published on the website, so the contestant, the viewer or the judge is enabled to view and enquiry.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flowchart illustrating the method of online painting competition processed through wired or wireless internet according to one preferred embodiment of the present invention;

FIG. 2 is a detailed flowchart illustrating a contestant inputting process according to one preferred embodiment of the present invention; and

FIG. 3 is a detailed flowchart illustrating providing a viewer or a judge inputting process according to one preferred embodiment of the present invention.

### DETAILED DESCRIPTION OF THE PREFERRED EMBODIMENT

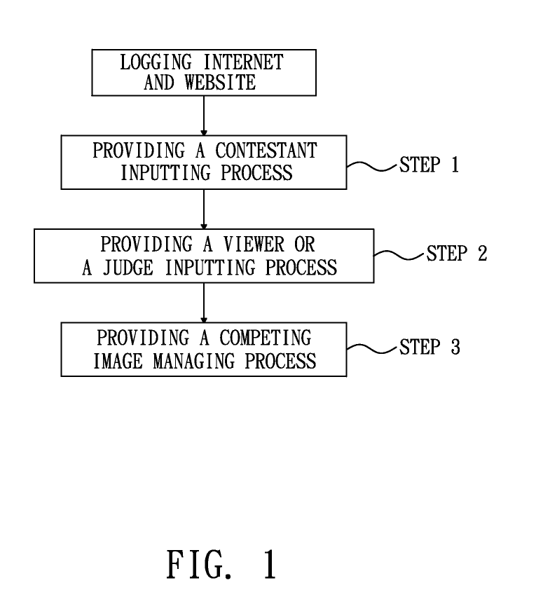

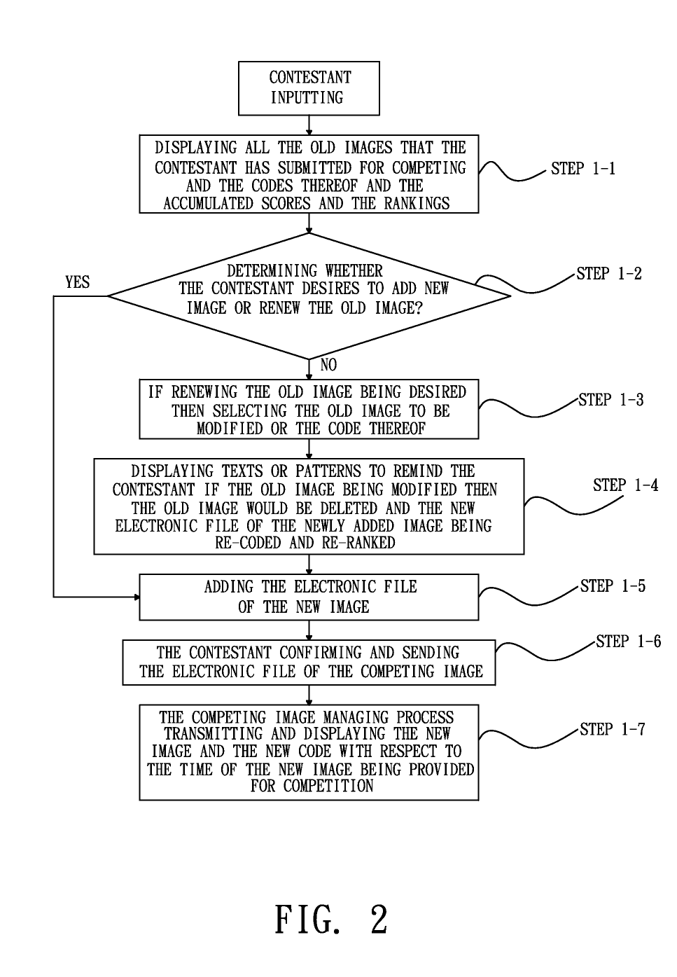

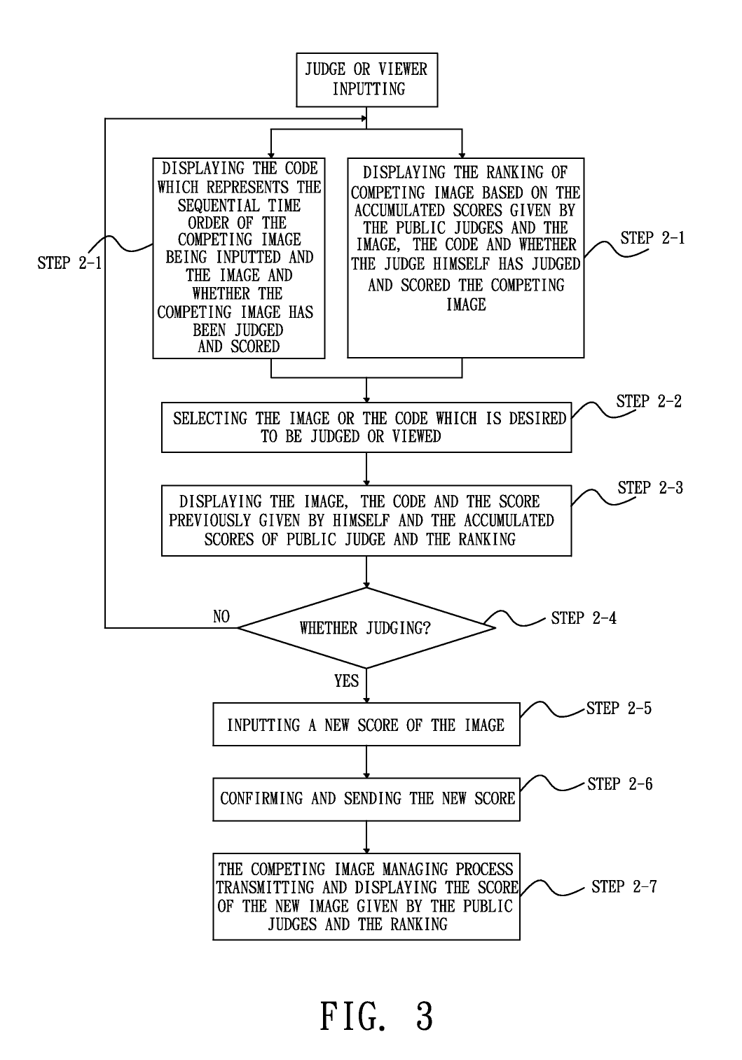

Referring from FIG. 1 to FIG. 3, wherein FIG. 1 is a flowchart illustrating the method of online painting competition processed through wired or wireless internet according to one preferred embodiment of the present invention; FIG. 2 is a detailed flowchart illustrating a contestant inputting process according to one preferred embodiment of the present invention; and FIG. 3 is a detailed flowchart illustrating providing a viewer or a judge inputting process according to one preferred embodiment of the present invention.

As shown in FIG. 1, the present invention provides a method of online painting competition processed through a wired or wireless internet, which allows at least a contestant, at least a viewer or a judge to login a website through an internet for participating the online painting competition, and includes the following steps: providing a contestant inputting process (STEP 1), wherein after logining the website, the at least a contestant inputs at least an electronic file of a competing image, and the contestant is enabled to view, enquiry or modify the competing image afterwards through the internet; providing a viewer or a judge inputting process (STEP 2), after the at least a viewer or judge logins the website, a part or all of the competing images are allowed to be viewed or to be judged, if judging is desired, the selected competing image is judged and scored for allowing other judges or viewers to be online to view, enquiry or modify the score afterwards; providing a competing image managing process (STEP 3), the process is served to input the electronic file of the image submitted by the at least a contestant then store and in sequence code the electronic files of the competing images with respect to the register time, and after the score given by at least a judge is inputted and saved, the scores given by all public judges are accumulated and calculated for ranking based on the accumulated scores; and the two types of rankings are in sequence published on the website, so the viewer or the judge is enabled to view and enquiry.

In the STEP 1: providing a contestant inputting process, after logging in, the at least a contestant inputs at least an electronic file of a competing image, i.e. the number of competing images is not limited for the contestant, and the contestant is enabled to view, enquiry or modify the competing image afterwards through the internet; wherein, the competing image is e.g. but not limited to an electronic painting, electronic photography or an electronic file of an image synthetized by the above two. In addition, after the contestant inputs the electronic file of the competing image to the website, and he/she desires to modify the image or replace with a new image, the STEP 1 provided by the present invention also allows the contestant to view and enquiry the accumulated scores given by the where public judges or modify the competing image.

Moreover, the method of online painting competition processed through the wired or wireless internet provided by the present invention also includes a process of the viewer becoming a contestant or a judge, which can be done by directly selecting the contestant inputting process or the viewer and the judge inputting process (not shown in figures), the arranged location is preferably to be on the webpage thereby facilitating the general viewer to become the contestant or the judge, as such, not only the number of contestants can be increased, but also the number of judges can be increased without raising the cost, each judge can score the image which he/she desires to judge, so the subjectivity of a few judges can be minimized, and the result of judging can be more close to the expectations of the public.

As shown in FIG. 2, in the step of providing a contestant inputting process, following steps are further included: displaying all the old images that the contestant has submitted for competing and the codes thereof and the accumulated scores and the rankings (STEP 1-1); determining whether the contestant desires to add new image (STEP 1-2); if adding new image being desired then go to STEP 1-5; if renewing the old image being desired then selecting the old image to be modified or the code thereof (STEP 1-3); after selecting the old image or the coded thereof, displaying texts or patterns to remind the contestant if the old image being modified then the old image would be deleted and the new electronic file of the newly added image being re-coded and re-ranked (STEP 1-4); adding the electronic file of the new image (STEP 1-5); the contestant confirming and sending the electronic file of the new competing image (STEP 1-6); and the competing image managing process is served to transmit and display the new image and the new code with respect to the time of the new image being provided for competition and the accumulated score of public judge becomes zero (STEP 1-7).

In the STEP 1-1, after the contestant logins in, all of the old images and the codes thereof and the accumulated scores given by the publics and the rankings relative to the contestant are displayed.

In the STEP 1-2, the contestant determines whether adding new image or renewing the old image; wherein the present invention allows the contestant to add new image or renew the old image after submitting, until the contestant fully satisfy with his/her image for competition or until the deadline for submitting the electronic file of the competing image.

In the STEP 1-3, if the old image is desired to be renewed, the image to be modified or the code thereof is selected thereby allowing the contestant to renew the old image; the contestant is allowed to delete the old image and input the electronic file of the new competing image (not shown in figures).

In the STEP 1-4, if the old image is desired to be renewed, texts or patterns are displayed for reminding the contestant that if the old image is modified, the old image would be deleted and the electronic file of the newly added image is subject to re-code and re-ranking.

In the STEP 1-5, the electronic file of a new image is added; wherein if the contestant desires to renew the old image, the old image would be deleted and the newly added image is subject to re-code and re-ranking, the old image selected by the contestant is replaced by the newly added image, or if the STEP 1-2 determines the contestant desires to add new image, then the STEP 1-5 is directly processed for adding the electronic file of the new image.

In the STEP 1-6, the contestant confirms and sends the electronic file of the new competing image; wherein the contestant inputting process is served to automatically input the image file to a competing image managing process (not shown in figures).

In the STEP 1-7, the competing image managing process transmits and displays the new image and the new code with respect to the time of the new image being provided for competition; wherein, the competing image managing process is served to reorder and recode the new competing image with respect to the time of the new image being participated the competition, thereby the contestant being enabled to know the new ranking of the new image.

In the STEP 2: providing a viewer or a judge inputting process, after the at least a viewer or the at least a judge logins the website, he/she is allowed to select a part or all of the competing images for the purpose of viewing or judging, if the judging is desired, the selected competing image is judged and scored thereby allowing other judges or viewers to view or enquiry afterwards through the internet or modify the score in the future.

As shown in FIG. 3, the step of providing a viewer or a judge inputting process further includes the following steps: displaying the code which represents the sequential time order of the competing image being inputted and the image and whether the competing image has been judged and scored; displaying the ranking of competing image based on the accumulated scores given by the public judges and the image, the code and whether the judge himself/herself has judged and scored the competing image (STEP 2-1); the judge or the viewer selects the image or the code which is desired to be judged or viewed (STEP 2-2); displaying the image, the code and the score previously given by himself/herself and the accumulated scores of public judge and the ranking (STEP 2-3); determining whether judging the image (STEP 2-4); if not judging the image, then go back to the STEP 2-1, if judging being desired, then inputting a new score of the image (STEP 2-5); confirming and sending the new score (STEP 2-6), the judge or the viewer inputting process is served to automatically input the score to the competing image managing process (not shown in figures); the competing image managing process is served to transmit and display the score of the new image given by the public judges and the ranking (STEP 2-7).

In the STEP 2-1, the code which represents the sequential time order of the competing image being inputted and the image and whether the competing image has been judged and scored by the judge himself/herself are displayed; the ranking of competing images based on the accumulated scores given by the public judges and the corresponding images, the codes and whether the judge himself/herself has judged and scored the competing image are displayed; the purpose of this step is to allow the judge and the viewer to be aware the accumulated scores of public judge of the competing image and the ranking thereof, the code which represents the sequential time order of the competing image being inputted, and whether the judge himself/herself has judged and scored the competing image thereby preventing multiple judging; the input time is determined by the system time recorded in the computer of the website after the contestant inputs the electronic file of the competing image and the website finishes the receiving operation, then a code is given to the electronic file of the competing image based on the sequential order of the receiving time, for example, with respect to the sequential order of time, the first inputting electronic file of the competing image is coded as 1, the second inputting electronic file of the competing image is coded as 2 and so on; the accumulated score of public judge is determined by accumulating total scores given by all of the publics to the image so as to rank the competing image, for example, the image which is inputted the first and coded as 1 has the accumulated score of 100 points from the public judge, the image which is inputted the second and coded as 2 has the accumulated score of 300 points from the public judge, so based on the accumulated score of public judge and the rankings, the image having the 300 points is ranked as NO. 1, the image having the 100 points is ranked as NO. 2, and so on; if these competing images and the codes thereof have already been judged by the judge, the code of the image is provided with a mark, for example, the competing image which has already been judged by the judge himself/herself is marked in the red font, if the competing image which has not yet been judged by the judge himself/herself is marked in the black or blue font, after the judge scores the competing image and inputs to the website, the competing image managing process is served to change the color font for being stored (not shown in figures).

In the STEP 2-2 or the STEP 2-3, the judge firstly selects the competing image or the code which he/she desires to judge or view, then the website displays the image, the code and the score that the judge previously gave and the accumulated score of public judge and the ranking for providing reference to the judge or the viewer.

In the STEP 2-4 and the STEP 2-5, the present invention firstly determines whether the judge desires to judge the image, if the judge does not desire to judge the image, then he/she can select to go back to the STEP 2-1, if the judge desires to judge the image, then after the judging and scoring, the score of the image is inputted thereby allowing the competing image managing process to accumulate the scores given by the public judges and the rankings.

In the STEP 2-6, after the new score is confirmed and sent, the competing image managing process is served to store all of the electronic files of the competing images, the codes based on the sequential time order of the electronic files of the competing images being inputted to the website, the individual score of the public judge and the accumulated scores of the all public judges and the rankings based on the accumulated scores.

In the STEP 2-7, the competing image managing process is served to transmit and display the new score of the image given by the judge and the latest accumulated scores of the public judge and the rankings on the website thereby providing reference to the judge and storing relative information.

In the STEP 3, the competing image managing process (not shown in figures) is served to have all the electronic files of the competing images being coded with respect to the system time of the electronic file being inputted to the website, and publish the sequential order of the codes on the website with a means of showing the firstly inputted file and so on, thereby allowing the contestant, the judge and the viewer to enquiry; because limited content is capable of being shown in single webpage, the earlier registration would result in being coded in higher priority which means having more chances to be shown on the main page of the website, so more chances for being viewed and judged by the public; the competing image managing process is served to collect the accumulated scores of the public judge for all of the competing images for the purpose of ranking, and the ranking would be published on the website thereby allowing the contestant, the judge or the viewer to enquiry, the final result of the competition is the ranking based on the accumulated scores of the public judge; the competing image managing process is also served to record the score of the judged competing image given by individual public judge and display with different color fonts on the website for allowing the judge to be aware of whether himself/herself has already judged the image when he/she desires to view or judge again.

As what has been disclosed above, the following advantages can be achieved by the method of online painting competition processed through wired or wireless internet provided by the present invention: 1. because only electronic files are adopted, any modification can be done without wasting papers or painting materials, thereby providing the environmental protection function; 2. the publics are enabled to view and judge after coding with respect to the sequential order of the inputting time defined by the contestant submitting the electronic file of the competing image and ranking based on the accumulated score given by the public judges; and the final result of the competition is the rankings based on the accumulated score of the public judge after the preset time period for the competition; the competition result is judged by the public judges so the subjectivity of only a few number of judges would not affect the fairness of the competition; accordingly, the method of online painting competition processed through wired or wireless internet provided by the present invention is novel and particle in use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A method of online painting competition processed through wired or wireless internet, allowing at least a contestant, at least a judge or at least a viewer to login a website through a wired or wireless internet for participating said online painting competition, and including following steps:
providing a contestant inputting process, wherein after logining said website, said at least a contestant inputting at least an electronic file of a competing image, and said contestant being enabled to view, enquiry or modify said competing image afterwards through said internet;
providing a viewer or a judge inputting process, wherein after said at least a viewer or judge logining said website, a part or all of said competing images being allowed to be viewed or to be judged, if judging being desired, said selected competing image being judged and scored for allowing other judges or viewers to be online to view, enquiry or modify said score afterwards;
providing a competing image managing process, wherein said electronic file of said image submitted by said at least a contestant being inputted and stored and said score given by said at least a judge being inputted and stored and ranking based on the accumulated scores given by the public judges; then said rankings is in sequence published on said website thereby allowing said contestant, said viewer or said judge to view and enquiry.

2. The method of online painting competition processed through wired or wireless internet as claimed in claim 1, wherein said step of providing a contestant inputting process further includes:
after said contestant inputs said electronic file of said competing image, said competing image is coded with respect to the system time of said electronic file being inputted to said website, and published on said webpage, thereby allowing said contestant, said viewer or said judge to view or enquiry.

3. The method of online painting competition processed through wired or wireless internet as claimed in claim 1, wherein said step of providing a contestant inputting process further includes:
determining whether said contestant desires to add new image or renew said old image;
if renewing said old image being desired then selecting old image to be modified or said code thereof;
displaying texts or patterns to remind said contestant if said old image being modified then said old image would be deleted and said new electronic file of said newly added image is re-coded and re-ranked;
adding said electronic file of said new image;
said contestant confirming and sending said electronic file of said competing image;
and said competing image managing process is served to transmit and display said new image and said new code with respect to the time of said new image being inputted for competition.

4. The method of online painting competition processed through wired or wireless internet as claimed in claim 1, wherein said step of providing a viewer or a judge inputting process further includes:
displaying said code which represents the sequential time order of said competing image being inputted and said image thereof and said ranking based on said accumulated scores given by said public judges and whether said competing image has been judged and scored by said judge himself/herself;
said judge selects said competing image or said code thereof which is desired to be judged or viewed;
displaying said image, said code and said score previously given by the judge himself/herself and said accumulated scores of public judge and said ranking;
determining whether said judge desires to judge said image;
if said judge desires to judge said image, said judges selects said image or said code of said image, inputs a new score of said image, then confirms and sends said new score; and said competing image managing process is served to transmit and display said score of said new image given by said public judges and said ranking;
if said judge does not desire to judge said image, then back to displaying said code which represents said sequential time order of said competing image being inputted and said image thereof and said ranking based on said accumulated scores given by said public judges and said image and whether said competing image has been judged and scored by said judge himself/herself.

5. The method of online painting competition processed through wired or wireless internet as claimed in claim 1, wherein said image is an electronic painting, electronic photography or an electronic file of an image synthetized by said above two.
